(19) United States
(12) Patent Application Publication
(10) Pub. No.: US 2013/0242566 A1
(43) Pub. Date: Sep. 19, 2013

(54) LIGHT EMITTING DIODE LAMP

(71) Applicant: SAMSUNG ELECTRONICS CO., LTD., Suwon-si (KR)

(72) Inventor: Sung Jin KIM, Suwon-si (KR)

(73) Assignee: SAMSUNG ELECTRONICS CO., LTD., Suwon-si (KR)

(21) Appl. No.: 13/779,714

(22) Filed: Feb. 27, 2013

(30) Foreign Application Priority Data
Mar. 16, 2012 (KR) 10-2012-0026945

(51) Int. Cl. F21V 7/00; F21V 13/04

(52) U.S. Cl. CPC F21V 7/00; F21V 13/04
USPC 362/308; 362/362; 362/296.01; 362/311.02

(57) ABSTRACT

A light emitting diode (LED) lamp is provided. The LED lamp may include a mounting housing including a printed circuit board (PCB) in the form of a circular or annular disc, at least one LED disposed on the PCB, and a preferably light-directing cover portion shaped corresponding to a shape of the PCB and connected to the mounting housing to cover the PCB to which the at least one LED is mounted, thereby covering the at least one LED. Since light emitted from the at least one LED is directional, a directional LED lamp may be implemented. In addition, the LED lamp may further include a reflector detachably connected to the mounting housing or the cover portion, and configured to reflect the light emitted from the at least one LED in directions including plural, lateral, e.g. radial, outward and/or downward directions from a central longitudinal axis of the mounting housing.

### CROSS-REFERENCE TO RELATED APPLICATION

This application claims the benefit of Korean Patent Application No. 10-2012-0026945, filed on Mar. 16, 2012, in the Korean Intellectual Property Office, the disclosure of which is incorporated herein by reference.

### BACKGROUND

1. Technical Field

The present disclosure relates to a light emitting diode (LED) lamp, and more particularly, to an LED lamp implementing omni-directional or directional emitted light according to whether a securely connectable but detachable reflector is connected thereto.

2. Description of the Related Art

A light emitting diode (LED) refers to a semiconductor device that emits light as an electric current flows. That is, the LED refers to a p-n junction diode including gallium arsenic (GaAs), Ga nitride (GaN) optical semiconductors, as an electronic part that converts electrical energy to optical energy.

Recently, a blue LED and an ultraviolet (UV) LED using nitrides having excellent physical and chemical characteristics have been introduced. Since the blue LED or UV LED may implement white light or other monochromatic lights using a phosphor material, an application field of the LED is expanding.

The LED has a relatively long life, and may be implemented in a small size and a low weight. Also, since the LED has strong directivity of light emission, low-voltage driving is available. In addition, the LED is durable against impact and vibration and does not require preheating and complicated driving and therefore is applied to various uses. For example, in recent days, the application fields of the LED are expanding from small lighting for a mobile terminal to general interior and exterior lighting, vehicle lighting, a backlight unit (BLU) for a large-area liquid crystal display (LCD), and the like.

General lighting such as an incandescent lamp and a compact fluorescent lamp (CFL) emit light omni-directionally due to characteristics of their light sources. Since most lighting devices are manufactured according to this omni-directional characteristic, a lamp embodying the LED has to emit light omni-directionally. Omni-directional as used herein is intended broadly to refer to light emissions that, rather than being directed substantially along a unidirectional path or axis, instead are directed along multiple (but not necessarily all) different axes emanating from the light source.

However, when the LED lamp is used as a down light to emit light in a downward direction, the LED needs to be directional. In this regard, a lamp device such as a reflector needs to be used in spite of a certain degree of light loss.

That is, after one of different types of LED lamps is selected according to required directivity, and then the selected LED lamp is connected to the lamp device. However, in this case, since a great number of LED lamps are to be used, use and maintenance costs and complexities including materials and labor (e.g. labor expended to replace one or more LED lamps) may increase.

Accordingly, there is a desire for a new LED lamp achieving both directional and omni-directional light.

### SUMMARY

An aspect of the present disclosure provides a light emitting diode (LED) lamp capable of achieving omni-directional or directional light emitted from an LED using a structure in which a reflector is connected to or separated from a mounting housing including an LED.

Another aspect of the present disclosure provides an LED lamp capable of minimizing optical loss by connecting or separating a reflector according to use conditions, and accordingly increasing emission efficiency.

Still another aspect of the present disclosure provides an LED lamp implementing required directivity of light by connecting a selected one of a plurality of reflectors to a mounting housing, and accordingly reducing costs since replacement of the entire lamp is unnecessary.

According to an aspect of the present disclosure, there is provided a light emitting diode (LED) lamp including a mounting housing including a printed circuit board (PCB) in the form of a circular or so-called “hollow” (i.e. having a concentric through hole therein) or annular disc, at least one LED disposed (e.g. mounted) on the PCB, and a cover portion shaped to correspond to a shape of the PCB and connected to the mounting housing to cover the PCB on which the at least one LED is mounted, thereby covering the at least one LED, wherein light emitted from the at least one LED is directional.

Plural ones of the at least one LED may be arranged at uniform distances or spacings across or along the PCB, and the cover portion may be provided in a circular annular shape so as to cover the plural LEDs.

The cover portion may include a pair of side cover members disposed at opposite sides of the PCB to which the at least LED is mounted, along the PCB, and an upper transmission member configured to connect upper ends of the pair of side cover members and to transmit the light emitted from the at least one LED to the outside of the housing.

A distance or angle between the pair of side cover members may increase toward the mounting housing in a downwardly, inwardly tapered form, and the mounting housing may include an insertion groove in which first ends of the pair of side cover members are inserted and fitted or otherwise connected.

The pair of side cover members may be made of an opaque or translucent material, and the upper transmission member may be made of a transparent material.

The LED lamp may further include a reflector detachably connected to the mounting housing or to the cover portion, and the reflector configured to reflect the light emitted from the at least one LED in other directions including laterally outward (e.g. radial) or laterally outward and downward (radial) directions.

The reflector may be detachably connected to the mounting housing or the cover portion by being partially inserted in an interior round region of the mounting housing defined with an annular outer region of the cover portion, in what will be referred to herein as an interference fit.

The LED lamp may further include at least one connection portion of which one end is fixed to the reflector and an opposite end is detachably connected to the mounting housing or to the cover portion.

The reflector may be provided in a funnel shape of which a diameter increases in a direction away from the mounting housing, the reflector extending to at least a part of an upper area of the cover portion.

At least a part of the reflector may be curved so that the light emitted from the LED is reflected from the reflector and directed to a front (upper region), lateral sides, and lower lateral sides.

According to another aspect of the present disclosure, there is provided an LED lamp including a mounting housing including a PCB, at least one LED disposed on the PCB, a cover portion connected to the mounting housing to cover the PCB to which the at least one LED is mounted, thereby covering the at least one LED, and a reflector detachably connected to the mounting housing or the cover portion and configured to reflect light emitted from the at least one LED in other directions including lateral (e.g. radial) directions, wherein the light emitted from the at least one LED is reflected from the reflector and emitted omni-directionally when the reflector is provided.

The PCB may be provided in a circular or annular disc shape, plural ones of the at least one LED may be arranged at a uniform distance or spacing across or along the PCB, and the cover portion may be provided in an annular shape so as to cover plural ones of the at least one LED.

The LED lamp may further include at least one connection portion of which one end is fixed to the reflector and an opposite end is detachably connected to the mounting housing or to the cover portion.

The reflector may be provided in a funnel shape of which a diameter increases in a direction away from the mounting housing, the reflector extending to at least a part of an upper area of the cover portion.

### EFFECT

According to some embodiments of the present disclosure, omni-directional or directional light emitted from an LED may be achieved by a structure in which a reflector is connected to or separated from a mounting housing including an LED.

Additionally, according to some embodiments of the present disclosure, since a reflector may be connected or separated according to use conditions, optical loss may be minimized, and accordingly emission efficiency may be increased.

Additionally, according to some embodiments of the present disclosure, required directional light may be achieved by mounting a selected one of a plurality of reflectors to a mounting housing. Accordingly, since replacement of the entire lamp is not required as in related arts, material and labor costs may be reduced.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is an isometric view illustrating a light emitting diode (LED) lamp comprising one or more LEDs, according to an embodiment of the present disclosure;

FIG. 2 is a front view of FIG. 1;

FIGS. 3A and 3B are a cross-sectional front view and a top plan view, respectively, schematically illustrating the light-directing cover portion of the LED lamp of FIGS. 1 and 2 and a resulting directional light emitted from the one or more LEDs;

FIG. 4 is a diagram illustrating a state before a reflector is connected to the LED lamp shown in FIG. 1;

FIG. 5 is a diagram illustrating a state in which the reflector shown in FIG. 4 is applied to the LED lamp shown in FIG. 1;

FIG. 6 is a diagram schematically illustrating a state in which light emitted from the internal parts and the LED of FIG. 5 is reflected by the reflector at multiple, diffused angles from the light source;

FIG. 7 is a diagram illustrating an LED lamp according to another embodiment of the present disclosure; and

FIG. 8 is a diagram illustrating an LED lamp according to still another embodiment of the present disclosure.

### DETAILED DESCRIPTION

Reference will now be made in detail to exemplary embodiments of the present disclosure, examples of which are illustrated in the accompanying drawings, wherein like reference numerals refer to the like elements throughout. A following description is one of various aspects of the present disclosure. Also, the following description forms part of the detailed description of the illustrated embodiments.

However, in describing the embodiments, if detailed descriptions of related disclosed art or configuration are determined to unnecessarily make the subject matter of the present disclosure obscure, they will be omitted.

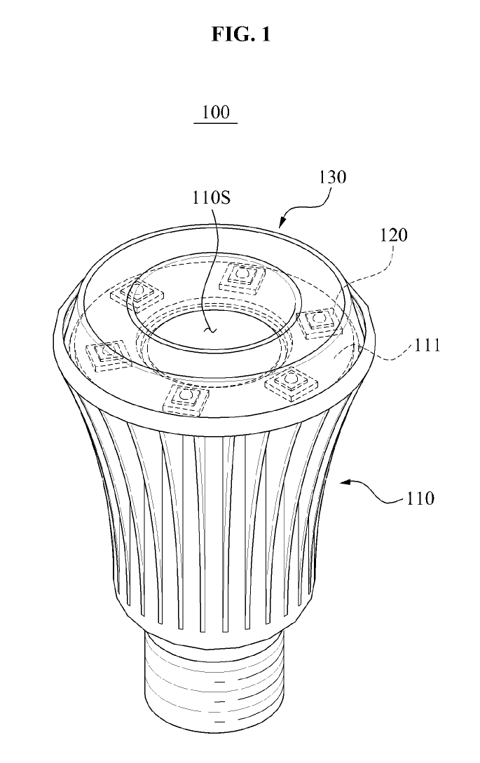

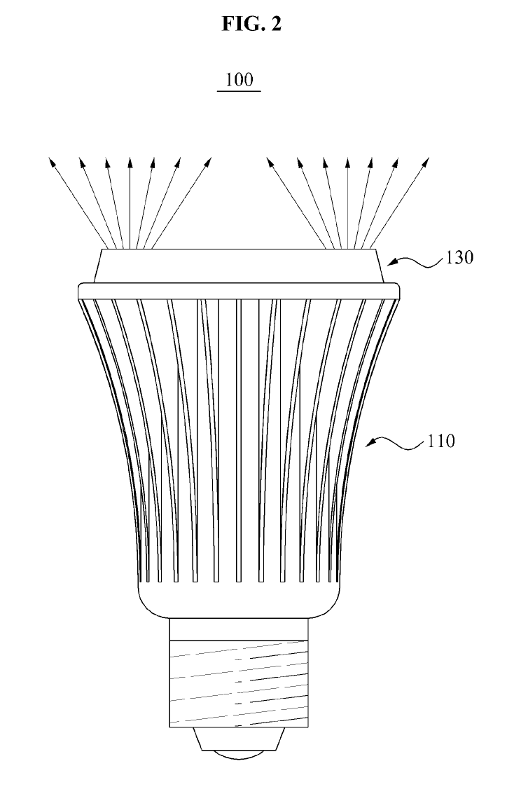

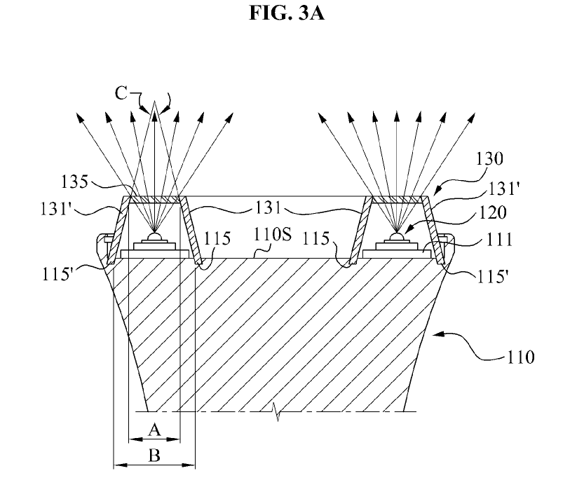

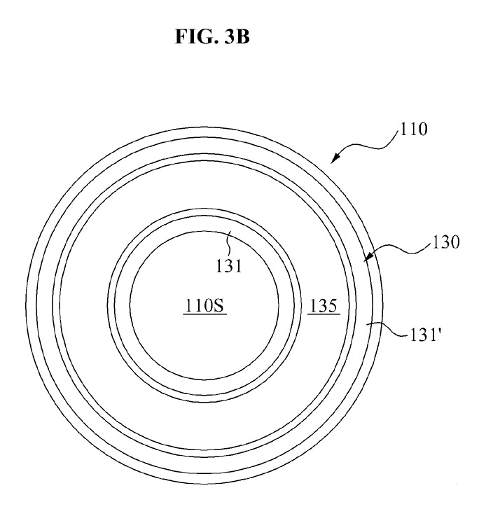

FIG. 1 is an isometric view illustrating a light emitting diode (LED) lamp according to an embodiment of the present disclosure. FIG. 2 is a front view of FIG. 1. FIGS. 3A and 3B are cross-sectional front and top plan views schematically illustrating a light-directing cover portion of the LED lamp and a resulting directional light emitted from the one or more LEDs of the LED lamp.

As shown in the drawings, the LED lamp 100 according to some embodiments may include a mounting housing 110 forming a basic appearance of the LED lamp and including an annular printed circuit board (PCB) 111 mounted along an outer circumference of an upper surface of the mounting housing 110 with reference to FIG. 1, a plurality of LEDs 120 arranged at uniform distances or spacing across or along an upper surface of the PCB 111, and a light-directing cover portion 130 connected to the mounting housing 110 to cover the LEDs 120 and the PCB 111. It will be understood that LED lamp 100 may also have a conventional base portion for threaded installation in a standard light bulb socket, and an optional conventional transformer (not shown) for converting alternating current (AC) to direct current (DC) if needed.

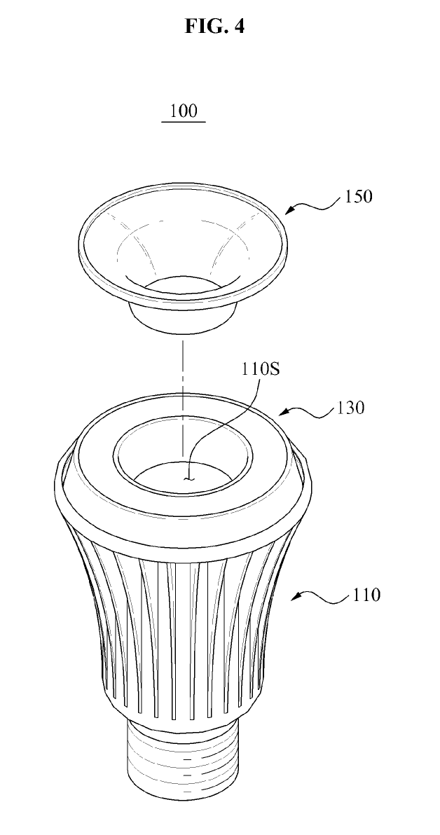

The LED lamp 100 may further include a detachable reflector 150 (refer briefly to FIGS. 4-8) configured to change a direction of light emitted from the LEDs 120 from the upward or forward direction to radial or plural lateral and/or lateral downward directions. The reflector 150 will be described later in further details in accordance with various illustrative but not limiting embodiments thereof.

As shown in FIG. 1, the mounting housing 110 mounts components such as the LEDs 120, and forms the overall shape and appearance of the LED lamp 100. The mounting housing 110 may have radial fins, as shown in FIG. 1, or its outer surface may be smooth or coated or textured or otherwise ornamented for aesthetic effect.

A substrate, for example, the PCB 111 of the present embodiment, may be mounted to one surface of the mounting housing 110. The PCB 111, being in the form of an annular disc, may extend along the outer circumference of the one surface of the mounting housing 110. Two or more, e.g. a plurality, of LEDs 120 may be mounted in an annular arrangement along the outer annular region of the annular PCB 111 and may be generally equally spaced therealong.

Referring to FIG. 1, a total of six LEDs 120 are arranged at uniform distances along the PCB 111, such that the light emitted from the LEDs 120 may illuminate the outside according to some embodiments.

Although not shown, each of the LEDs 120 may include a first type semiconductor layer, an active layer, and a second type semiconductor layer. By application of electric power, light may be emitted by recombination of electrons and holes at the active layer.

The light emitted from the LEDs 120 may be emitted to a front of the LED lamp as shown in FIG. 2. That is, directional light may be emitted away from the mounting housing 110 and toward the front of the lamp 100.

As shown in FIG. 2, the cover portion 130 may cover and protect the LEDs 120 and the PCB 111 mounting the LEDs 120, and guide the light emitted from the LEDs 120 toward the front of the LED lamp 100. For this purpose, the cover portion 130 may be in an annular shape corresponding to a shape of the PCB 111, with an upper region of the cover portion being selectively configured to transmit light.

In detail, as shown in FIGS. 3A and 3B, the light-directing cover portion 130 may include a pair of inner and outer annular side cover members 131 and 131′ disposed on the PCB 111 mounting the LEDs 120 (only two LEDs being shown in FIG. 3A, and neither the LEDs nor the PCB being shown in FIG. 3B, for the sake of clarity), and an upper transmission member 135 connected to upper ends of the pair of side cover members 131 and 131′. (It will be understood that less than all of this detail is shown in FIGS. 1 and 2 for the sake of clarity so as not to obscure the arrangement of the one or more LEDs and the PCB beneath the light-directing cover portion.)

The pair of side inner and outer cover members 131 and 131′ may be made of an opaque or translucent material not allowing much transmission of the light emitted from the LEDs 120. As shown in FIG. 3, a “distance” between the pair of side cover members 131 and 131′ may increase toward the mounting housing 110 to form what will be referred to herein as downwardly (i.e. toward the mounting housing) and outwardly angled sidewalls. (This increasing distance will be understood to correspond with the increase between distance A and distance B in FIG. 3A and the angle C represented thereby.) Lower ends of the pair of side cover members 131 and 131′ may be detachably connected in a corresponding pair of inner and outer insertion grooves 115 and 115′ formed on one surface 1105 of the mounting housing 110.

According to the shape of the pair of side cover members 131 and 131′ and the structure of the pair of insertion grooves 115 and 115′ being angled or inclined, when the lower ends of the pair of side cover members 131 and 131′ are firmly inserted into the corresponding insertion grooves 115 and 115′ of the mounting housing 110, the lower ends of the pair of side cover members 131 and 131′ may be securely connected within the insertion grooves 115 and 115′, so that a secure connection of the cover portion 130 with respect to the mounting housing 110 is maintained.

In addition, when the lower ends of the pair of side cover members 131 are firmly pulled from the mounting housing 110, the cover portion 130 may be easily separated from the mounting housing 110. That is, connection and separation of the light-directing cover portion 130 with respect to the mounting housing 110 may be performed with ease.

The upper transmission member 135 transmits the light emitted from the LEDs 120 and, for this purpose, may be made of a transparent material. The upper transmission member 135 may be disposed parallel with the front surface 1105 of the mounting housing 110 and may have a circular, circular-annular, or other suitable shape for connection with the pair of inner and outer side cover members 131 and 131′.

Owing to the shape of the cover portion 130, the light emitted from the LEDs 120 may become directional or uni-directional, e.g. the one or more LEDs may emit light outwardly from the front of the lamp 100. Thus, the LED lamp 100 may feature directional lamps as shown in FIG. 2.

Also, different from the above description, the LED lamp 100 may include omni-directional lamps. For this, the LEDs 120 may further include a reflector configured to reflect the light emitted from the LEDs 120 in other directions.

Various reflector embodiments now will be described with reference to FIGS. 4-8.

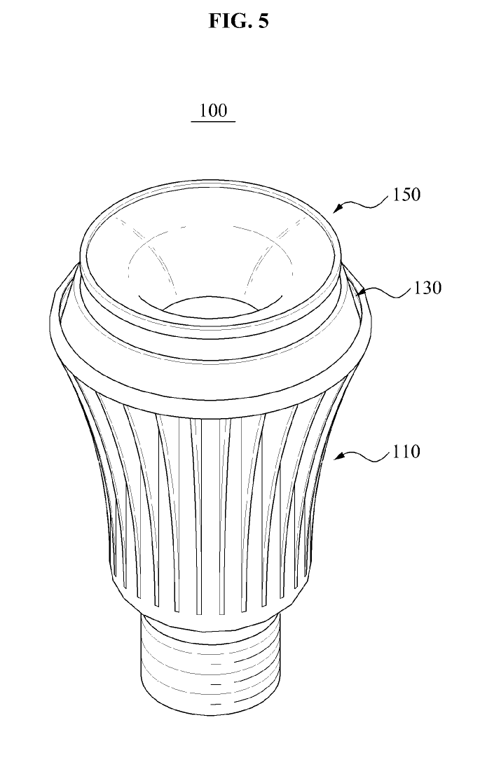

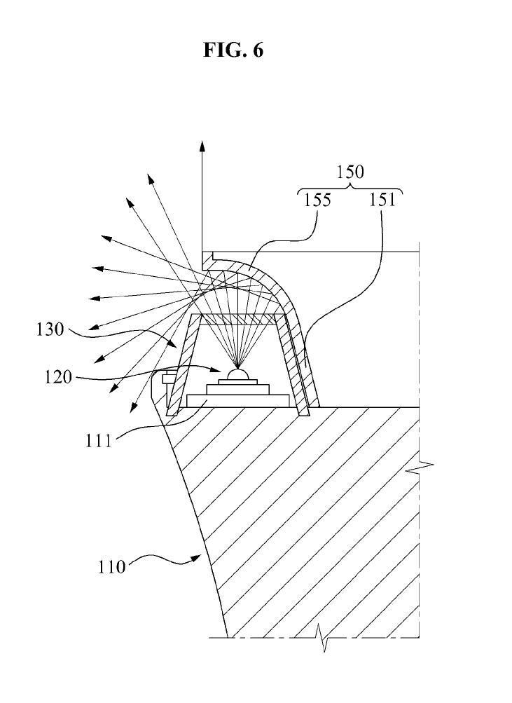

FIG. 4 is a diagram illustrating a condition of the invented lamp 100 before a reflector 150 is connected thereto. FIG. 5 is a diagram illustrating a condition in which the reflector 150 shown in FIG. 4 is applied to the LED lamp 100 shown in FIG. 1. FIG. 6 schematically illustrates a condition in which light emitted from the internal parts and the LEDs of FIG. 5 is reflected by the reflector into one or more generally radial, e.g. lateral or lateral and downward, rays or beams of light to produce an omni-directional LED lamp.

As shown in the drawings, the reflector 150 may be inserted in an inner space 110S defined by the annular cover portion 130 and detachably connected to the mounting housing 110. The reflector 150 may reflect the light emitted from the LEDs 120 in other directions, for example lateral (e.g. radial) directions, so that the light is emitted omni-directionally. Alternatively, the reflector 150 may be inserted into a concentric circular annular groove formed in an upper surface of a PCB that takes the form of a circular rather than an annular disk, with the reflector's bottom circular annular edge removably captured within the circular annular groove formed within the upper surface of the PCB's circular disk shape.

Referring to FIGS. 4 and 5, the reflector 150 may be in a substantial funnel shape. A lower end 151 of the reflector 150, directed to the mounting housing 110, may be shaped corresponding to the inner space 110S so as to be detachably connected to the mounting housing 110 or to the cover portion 130. An upper end 155 (FIG. 6) extended from the lower end 151 may cover a part of an upper area of the cover portion 130, thereby reflecting the light emitted from the LEDs 120.

Since the reflector 150 is configured to be selectively connected to the mounting housing 110 as necessary, connection and separation of the reflector 150 with respect to the mounting housing 110 or the cover portion 130 may be easily performed.

For example, a locking recess (not shown) may be formed on a surface of the mounting housing 110 to lock a lower end of the reflector 150, thereby achieving a secure connection between the mounting housing 110 and the reflector 150. Also, separation may be easily performed as necessary by releasing the locking structure between the mounting housing 110 and the reflector 150. However, the connection structure of the reflector 150 with respect to the mounting housing 110 or the cover portion 130 is not specifically limited to a locking recess and, in accordance with one embodiment of the invention, is achieved by a simple interference fit between reflector 150 and cover portion 130.

According to the aforementioned structure of the reflector 150, the light emitted from the LEDs 120 may be reflected by the reflector 150 and emitted to lower lateral sides, lateral sides, and upper lateral sides, and in an upward or partially frontal direction, that is, omni-directionally as shown in FIG. 6.

Thus, since direction of light emission may be conveniently controlled by connecting or separating the reflector 150, the LED lamp 100 may be used more efficiently. For example, in a case that the LED lamp 100 is provided on a ceiling of an interior space, an omni-directional lamp may be achieved by connecting the reflector 150 or a directional lamp may be achieved by separating the reflector 150 as demanded by a user.

According to the embodiment of the present disclosure, the light emitted from the LEDs 120 may become omni-directional or directional according to a connection state of the reflector 150 with respect to the mounting housing 110 including the LEDs 120 and the cover portion 130. In addition, since the reflector 150 is connected or separated according to use conditions, optical loss may be minimized, consequently increasing the optical efficiency of the LED lamp 100.

Furthermore, when one of a plurality of reflectors 150 is selectively connected to the mounting housing 110, a desired directivity of the light may be obtained. As a result, replacement of an entire lamp is not required as in related arts when it is desired by a user to change directivity. Therefore, cost may be reduced.

Hereinafter, an LED lamp according to another embodiment of the present disclosure will be described, omitting a description about the same structures as in the previous embodiment.

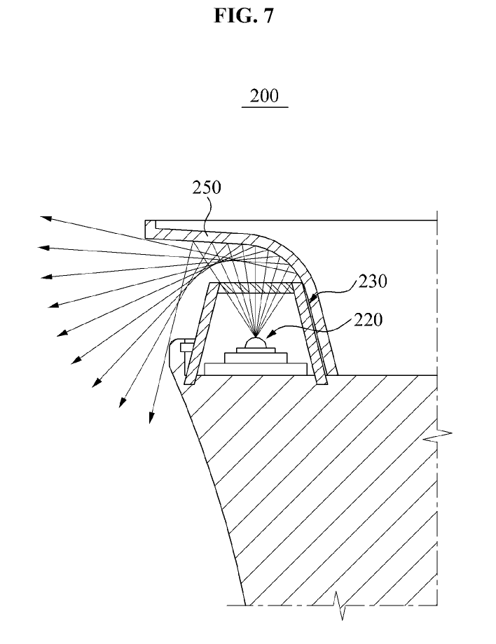

FIG. 7 is a diagram illustrating an LED lamp 200 according to another embodiment of the present disclosure in which a different one of a plurality of reflectors is used.

As shown in FIG. 7, the LED lamp 200 has substantially the same structure as the LED lamp 100 of FIG. 6 except for the shape of a reflector 250. The reflector 250 of the present embodiment covers an upper area of a cover portion 230 so that light emitted from LEDs 220 is restricted from emitting to a front of the LED lamp 200 but mainly is emitted radially, outwardly toward lateral sides or radially, outwardly and downwardly toward lower lateral sides.

In this case, since the light emitted from the LEDs 220 is reflected from the reflector 250 rather than being directly emitted, the light may be evenly dispersed without being focused on a certain area.

However, various types of reflectors not limited to the reflector 250 or the reflector 150 may be applied according to desired directivity of light. In this case, the desired directivity of light may be obtained by selecting one of various reflectors without having to replace the entire LED lamp. As a result, the cost may be reduced while the optical efficiency for a particular intended use of the LED lamp is increased.

Hereinafter, an LED lamp according to still another embodiment of the present disclosure will be described, omitting a description about the same structures as in the previous embodiments.

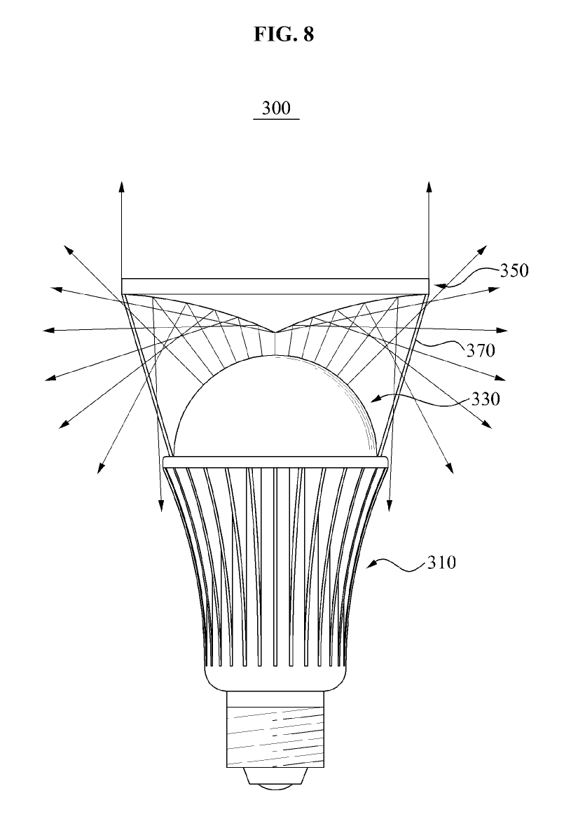

FIG. 8 is a diagram illustrating an LED lamp 300 according to still another embodiment of the present disclosure in which yet another one of the plurality of reflectors is used.

As shown in FIG. 8, the LED lamp 300 may include a mounting housing 310 including a PCB mounting a plurality of LEDs, and a dome-shaped cover portion 330 provided in a hemispherical shape and connected to the mounting housing 310 to cover the LEDs. The LED lamp 300 may further include a reflector 350 configured with symmetric internal light-reflecting surfaces to reflect light emitted from the LEDs radially outwardly and even downwardly, as shown. The reflector 350 may be detachably connected to the mounting housing 310 through a suitably configured, light-transmissive connection portion 370.

The reflector 150 in the previous embodiment illustrated in FIG. 4 is detachably connected in the inner space 110S formed between the mounting housing 110 and the cover portion 130 being in the annular shape. However, according to the present embodiment, one end of the connection portion 350 is connected to the reflector 350 whereas an opposite end is detachably connected to the mounting housing 310 through the connection portion 370 which is connectable to an outer wall of the mounting housing 310 by any suitable connection mechanism including a locking recess (not shown) or a simple interference fit.

According to the present embodiment, directional light emitted from the LEDs may be reflected by the reflector 350 omni-directionally, thereby implementing an omni-directional lamp. In addition, by separating the reflector 350 from the mounting housing 310, a directional lamp may also be implemented.

In the present embodiment, connection between the mounting housing 310 and the reflector 350 is achieved by the connection portion 370. However, any other methods or structures may be applied to connect and separate the reflector 350 with respect to the mounting housing 310.

In accordance with one embodiment of the invention, at least a portion, and preferably all, of the annular reflector is smoothly and concavely curved upwardly and outwardly away from a central longitudinal axis of the mounting housing, as is consistently illustrated herein in FIGS. 4-8. It will be understood that reflectors such as those described and illustrated herein may have any suitable reflecting cross-sectional shape, e.g. linear, circular, parabolic, or otherwise curvilinear, depending upon the desired application and its directivity and/or focus and/or collimated/diffused-light-emitting design requirements.

Although a few exemplary embodiments of the present disclosure have been shown and described, the present disclosure is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A light emitting diode (LED) lamp comprising:
a mounting housing including a printed circuit board (PCB) in the form of an annular disc;
at least one LED disposed on the PCB; and
a cover portion shaped corresponding to a shape of the PCB and connected to the mounting housing to cover the PCB to which the at least one LED is mounted, thereby covering the at least one LED,
wherein light emitted from the at least one LED is directional.

2. The LED lamp of claim 1, wherein
the at least one LED are plural LEDs arranged at a uniform distance or spacing along the PCB, and
the cover portion is provided in an annular shape so as to cover the plural LEDs.

3. The LED lamp of claim 2, wherein the cover portion comprises:
a pair of side cover members disposed on the PCB to which the plural LEDs are mounted along the PCB; and
an upper transmission member configured to connect upper ends of the pair of side cover members and to transmit the light emitted from the plural LEDs to the outside of the mounting housing.

4. The LED lamp of claim 3, wherein
the pair of side cover members are angled outwardly and downwardly relative to one another as they extend toward the mounting housing, and
the mounting housing comprises a corresponding pair of insertion grooves into which first ends of the pair of side cover members are inserted and connected.

5. The LED lamp of claim 3, wherein
the pair of side cover members are made of an opaque or translucent material, and
wherein the upper cover member is made of a transparent material.

6. The LED lamp of claim 1, further comprising a reflector detachably connected to the mounting housing or the cover portion, the reflector configured to reflect the light emitted from the at least one LED in other directions including lateral directions.

7. The LED lamp of claim 6, wherein the reflector is detachably connected to the mounting housing or the cover portion by being partially inserted into an inner space of the mounting housing defined by the cover portion.

8. The LED lamp of claim 6, further comprising at least one connection portion of which one end is fixed to the reflector and an opposite end is detachably connected to the mounting housing or the cover portion.

9. The LED lamp of claim 6, wherein the reflector is provided in a funnel shape of which a diameter increases in a direction away from the mounting housing, the reflector extending to at least a part of an upper area of the cover portion.

10. The LED lamp of claim 6, wherein at least a portion of the reflector is curved so that the light emitted from the LED is reflected from the reflector and directed radially outwardly away from a central longitudinal axis of the mounting housing.

11. A light emitting diode (LED) lamp comprising:
a mounting housing including a printed circuit board (PCB);
at least one LED disposed on the PCB;
a cover portion connected to the mounting housing to cover the PCB to which the at least one LED is mounted, thereby covering the at least one LED; and
a reflector detachably connected to the mounting housing or the cover portion and configured to reflect light emitted from the at least one LED in directions including lateral directions,
wherein the light emitted from the at least one LED is reflected from the reflector and emitted radially outwardly when the reflector is provided.

12. The LED lamp of claim 11, wherein
the PCB is provided in an annular disc shape,
the at least one LED are plural and are arranged at uniform distances or spacings along the PCB, and
the cover portion is provided in an annular shape so as to cover the plural LEDs.

13. The LED lamp of claim 12, wherein the reflector is detachably connected to the mounting housing or the cover portion by being partially inserted in an inner space of the mounting housing defined by the cover portion.

14. The LED lamp of claim 12, further comprising at least one connection portion of which one end is fixed to the reflector and an opposite end is detachably connected to the mounting housing or the cover portion.

15. The LED lamp of claim 12, wherein the reflector is provided in a funnel shape of which a diameter increases in a direction away from the mounting housing, the reflector extending to at least a part of an upper area of the cover portion.

16. A light emitting diode (LED) lamp comprising: a mounting housing including a printed circuit board (PCB) in the form of a circular or annular disk;
at least one LED disposed on the PCB; and
a light-directing cover portion shaped corresponding to a shape of the PCB and connected to the mounting housing to cover the PCB to which the at least one LED is disposed, thereby covering the at least one LED and thereby directing light emitting therefrom away from the mounting housing toward a front of the lamp,
wherein light emitted from the at least one LED is directional.

17. The LED lamp of claim 16, wherein the at least one LED are plural LEDs arranged around a circumferential outer region of the PCB, and wherein the cover portion is provided in an annular shape so as to cover the plural LEDs.

18. The LED lamp of claim 17 further comprising:
a reflector configured to fit securely but detachably within a hole in the cover portion defined by the cover portion's annular shape, the reflector when so securely fit configured to reflect light emitted from the plural LEDs radially outwardly and substantially omni-directionally away from the mounting housing.

19. The LED lamp of claim 18, wherein the reflector is provided in a funnel shape of which a diameter increases in a direction away from the mounting housing, the reflector extending to at least a part of an upper area of the cover portion.

20. The LED lamp of claim 19, wherein the reflector is generally annular, and wherein the reflector in cross section curves concavely upwardly and outwardly away from a central longitudinal axis of the mounting housing.
